(19) United States
(12) Patent Application Publication
(10) Pub. No.: US 2007/0131626 A1
(43) Pub. Date: Jun. 14, 2007

(54) Method and apparatus for producing oxygen enriched water

(75) Inventor: Thirumal Chandran, Pune (IN)

Correspondence Address: GEORGE R. REARDON, 3356 STATION COURT, LAWRENCVILLE, GA, 30044, US

(73) Assignee: RASIKLAL MANIKCHAND DHARIWAL

(21) Appl. No.: 11/298,996

(22) Filed: Dec. 9, 2005

(51) Int. Cl. C02F 1/72

(52) U.S. Cl. 210/758

(57) ABSTRACT

A method for dissolving oxygen into water comprised of diffusing oxygen in small, fine bubbles at the bottom of a water column in a closed vessel, building headspace pressure above the water column in the vessel, and circulating the oxygen from the headspace continuously till the desired oxygen dissolved concentrate of water is obtained. An apparatus for dissolving oxygen into water, comprised of an enclosed vessel, porous metallic diffusers, an agitator, a rotary hollow-shaft extending till the bottom end of the water column, a venturi slot on the hollow-shaft configured to stay above the water level, and a disc at the bottom end of the rotary hollow-shaft.

### FIELD OF THE INVENTION

The invention is generally directed to a method and an apparatus for dissolving a gas into water. More particularly the invention relates to a method and an apparatus for dissolving oxygen into water to increase the proportion of oxygen therein.

### BACKGROUND OF THE INVENTION

It is no secret that oxygen and water are the two most basic essentials of life and energy. Oxygen is a natural energizer and body purifier. Water contains oxygen, but in a very low proportion, e.g., 5-6 ppm.

Since all of the body's activities are regulated by oxygen, the making of sufficient levels of oxygen available to every part of the body promotes optimum health and a person's ability to think and act effectively. Just as the body's need for sufficient healthy foods, pure healthy water and exercise have been firmly established; the body's need for sufficient levels of oxygen has also been firmly established.

It is also established that the human body is approximately 70% water. Medical associations have recommended eight glasses of water as an average daily requirement in order to have optimum health. Water contains no calories, serves as an appetite suppressant, and helps to metabolize stored fats in the body. Water helps regulate the body's temperature, dissolves the body's waste products, and flushes out the body's toxins. Water is also necessary to maintain proper muscle tone and proper digestion.

There is no substitute for inadequate oxygen. When the body is oxygen deficient, it is not equipped to have proper chemical reactions occur throughout the body. Without oxygen, the blood and cells are weakened and impaired from disposing of waste efficiently. All body cells are weakened and impaired of their functioning if deprived of oxygen. In fact some cells, if deprived of oxygen, may mutate into colonies of disease in their attempt to survive. Brain cells die in just 15 seconds if deprived entirely of oxygen. It has been suggested that the lack of a need for oxygen is a property of cancer cells that uniquely distinguishes them from normal cells.

Oxygen is also critical to the healing process. It is believed that an increase in the available level of oxygen helps red blood cells to pick up the extra oxygen and become energized. Thus, the body retains the capability to remove waste gases and toxins efficiently and the cells begin to function normally. Anaerobic viruses, bacteria and fungi are neutralized, and body chemical reactions are charged up. When the oxygen level in the blood is up, one feels better, energetic, healthier, and the brain gets purified.

Since, the body cannot store oxygen, it depends on a life-long steady supply to sustain life. One of the ways the body gets oxygen is by breathing air. The atmospheric air is known to contain about 21% oxygen, which is absorbed into one's lungs. The lungs attach oxygen to red blood cells (hemoglobin) and the blood stream transports it to the cells of various organs and muscles in the body. In the cells, energy is released and used.

As one get older, the body develops various degrees of oxygen shortages in the blood stream, due to the fact that respiratory and circulatory systems do not work at full capacity. Those who smoke have had prolonged exposures to polluted air, and those who have other respiratory illnesses suffer from even greater diminished lung capacity. Therefore, it is not unusual for the air volume in one's lungs to drop from the average 5 to 7 liters down to 3 to 4 liters as the body ages and gets exposed to harmful environment conditions. This represents a 40% loss in lung capacity, and a resulting loss in blood oxygen saturation. Stress, malnutrition, illness and lack of physical activities can also contribute to reductions in oxygen levels.

Increasing oxygen level in drinking water can enhance the availability of oxygen to the body that occurs through breathing atmospheric air. Under ambient conditions of pressure and temperature oxygen solubility in water varies from 6.5 mg/lit. to 13 mg/lit.; on naturally occurring water, surface or underground, the dissolved oxygen concentration is from 5 mg/lit. to 11 mg/lit. In view of the development of industry and the corresponding increase in pollutant discharges, in most of the naturally available sources of water there is a depletion of oxygen and there is growing awareness among the populace to opt for bottled water, whenever there is uncertainty concerning the naturally available water.

To summarize, when there is inadequate oxygen in the body, physical energy is drained, the body is unable to function properly and one just does not feel right. Oxygen is critical to good health and general well being.

While this published patent application and other previous methods have attempted to solve the above mentioned problems, none have utilized or disclosed systems and methods that allow uses to create complex, custom, credit attributes by means of a graphical interface.

Therefore, a need exists for a method and an apparatus for dissolving a greater proportion of oxygen than found in normal potable water. The method and apparatus according to the present invention substantially depart from the conventional concepts and designs of the prior art. It can be appreciated that there exists a continuing need for new and improved method and apparatus which can be used commercially. In this regard, the present invention substantially fulfills these objectives.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to increase the oxygen level in water. In particular, the present invention relates to providing a method and an apparatus for dissolving a greater proportion of oxygen than what is generally found in normal potable water.

The present invention provides a method and an apparatus for enriching water with dissolved oxygen, which is absorbed into the body when consumed. The method envisaged according to the present invention will operate at conditions of high oxygen solubility. Solubility of oxygen in water depends upon critical parameters, e.g., water temperature, water salinity, oxygen partial pressure.

Oxygen solubility is—
inversely proportional to water temperature,
inversely proportional to water salinity, and
is directly proportional to oxygen's partial pressure

By operating at suitable values of these parameters, among other parameters, in accordance with the present invention, high oxygen solubility in water is achieved.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further objects and advantages of the present invention will be apparent from the following detailed description of a presently preferred embodiment which is illustrated schematically in the accompanying drawings.

### BRIEF DESCRIPTION OF THE SEVERAL VIEWS OF THE DRAWINGS

Other advantages and features of the invention are described with reference to exemplary embodiments, which are intended to explain and not to limit the invention, and are illustrated in the drawings in which:

FIG. 1 illustrates a front plan view of an apparatus for dissolving oxygen into water, according to an embodiment of the present invention.

FIG. 2 is a graph that shows the relationship between water temperature and dissolved oxygen.

FIG. 3 is a graph that shows the relationship between water temperature and pressure to achieve different levels of dissolved oxygen.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

Since Oxygen is a sparingly soluble gas, its percentage (mole fraction) in gas phase is directly proportional to its percentage (mole fraction) in water. The proportionality constant varies with temperature. In mathematical form, this statement is presented as:
Y=H(T)X
Where,
Y—mole fraction of oxygen in the gas phase.
H(T)—temperature dependent proportionality constant.
X—oxygen's mole fraction in water.

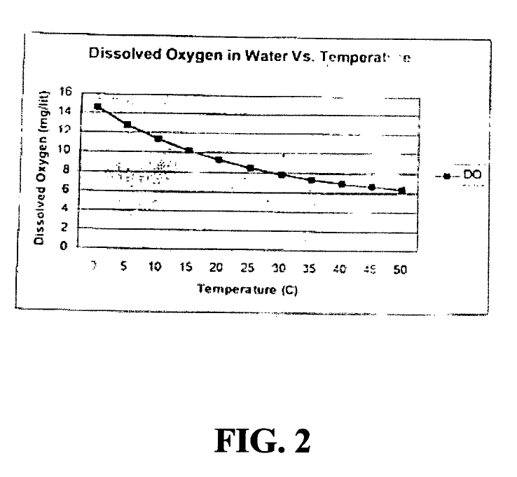

By using the above said formula, oxygen solubility in water under ambient conditions is plotted below as a function of temperature, as seen in FIG. 2. It should be noted that the air contains 21% oxygen; therefore, mole fraction of oxygen in the gas phase is 0.21.

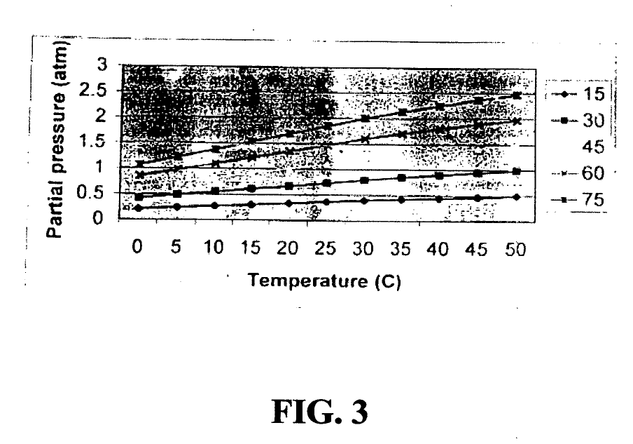

Referring now to FIG. 3, it can be seen that to achieve a dissolved oxygen concentration of 45 mg/lit. at normal water temperature of 25 C, the required oxygen partial pressure is about 1.5 atm.

The desired oxygen partial pressures may be achieved either by compressing air to a 5 times higher pressure, or by having pure oxygen at the desired pressure.

Under the circumstances discussed hereinabove, the process for increasing the dissolved oxygen level in water in accordance with the present invention revolves around tasks:
Reducing the water salinity;
Reducing water temperature;
Increasing the oxygen partial pressure; and
Improving the contact between oxygen and water, e.g., providing high interfacial area.

Low salinity is achieved by passing natural waters through membrane filters. Salinity of less than 100 mg/lit. is easily achieved by passing water through Reverse Osmosis membranes.

Water temperature is reduced through heat exchangers, such as shell and tube devices or jacketed vessels.

Increased oxygen partial pressure is achieved by either compressing air, or by feeding compressed oxygen into a pressure vessel.

Contact area between oxygen and water is improved by employing packed beds, or by diffusing the gas (air/oxygen) from the bottom of the pressure vessel, or by splashing water in pressurized gas (air/oxygen), or by employing a special agitator device. Gas diffusers made from various materials such as membranes, ceramics, sintered metals and the like are employed.

The apparatus envisaged according to the present invention for increasing dissolved oxygen in the water is a pressure vessel in which air or pure oxygen is injected into the vessel from the bottom of the pressure vessel through porous metal diffusers suitable for drinking water applications, which are capable of diffusing the gas into very fine bubbles.

The oxygen injected at the bottom of the reactor, after attaining saturation in the water column, raises through the water column in the form of very fine bubbles. The un-dissolved oxygen bubbles burst at the water surface, and this fills up the vessel headspace and pressure develops.

An agitator rotating at the center of the vessel has a hollow shaft, which extends up to the bottom end of the vessel. A venturi slot is provided at the top of the hollow shaft. A disc like device, or an impeller or the like device is provided at the bottom end of the hollow shaft. The water level in the vessel is maintained below the venturi slot in the hollow shaft. Suction is created in the venturi slots by the rotation of the agitator. Due to this suction, oxygen in the headspace gets sucked into the hollow shaft and gets discharged from the bottom end outlet. A disc like device (or an impeller or like device) at the bottom end of the hollow shaft continuously re-injects the oxygen into the water in the form of small bubbles. The continuous recycling of the unutilized oxygen in the headspace helps to attain super saturation of oxygen in water and thus improves efficiency of the process.

In accordance with a preferred embodiment of the invention, the water in the pressure vessel is cooled with heat exchanger devices located either inside or outside the vessel. The equipment may be operated in a batch mode or in a continuous mode.

According to an embodiment of the invention, a method for dissolving oxygen into water to increase the proportion is comprised of the steps of:
diffusing oxygen in small fine bubbles at the bottom of the water column in a closed vessel;
building headspace pressure above the water column in the vessel; and
circulating the oxygen from the headspace continuously till the desired oxygen dissolved concentrate of water is obtained.

According to an embodiment of the invention an apparatus for dissolving oxygen into water is comprised of:
an enclosed vessel;
built-in porous metallic diffusers at the bottom of the enclosed vessel;
an agitator at the top of the enclosed vessel (the agitator being further comprised of:
   a rotary hollow-shaft extending till the bottom end of the water column in the vessel;
   at least one venturi slot on the hollow-shaft configured to stay above the water level; and
   a disc at the bottom end of the rotary hollow-shaft.

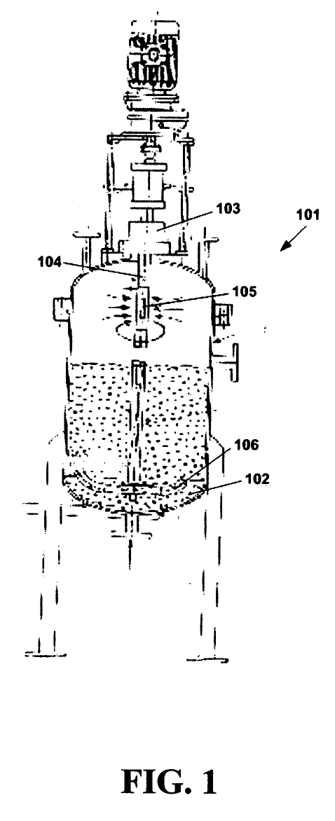

Referring to FIG. 1, enclosed vessel 101 is comprised of built-in porous metallic diffusers 102 which are disposed at the bottom of vessel 101. Agitator 103 is disposed at the top of enclosed vessel 101. Rotary hollow-shaft 104 is operably connected to agitator 103 and extends to the bottom end of the water column in the enclosed vessel 101. Venturi slot 105 is located on rotary hollow-shaft 104 and is configured to stay above the water level in enclosed vessel 101. Disc 106 is operably connected at the bottom end of rotary hollow-shaft 104. Disc 106 may be an impeller.

The table shown below is from actual trial conditions:

| Process parameter | Trial range |
|---|---|
| Water temperature | 10-30° C. |
| Water salinity | 50-1000 mg/lit. |
| Oxygen partial pressure | 0.3-2.0 kg/cm² |
| Mode of operation | Continuous flow |
| Hydraulic retention time | Up to 1 hour |
| Agitator rpm | 60-150 |

At the above operating conditions, in the water, dissolved oxygen concentrations of 20 mg/lit. to 60 mg/lit. were obtained.

I claim:

1. A method for dissolving oxygen into water to increase the proportion thereof, comprised of the steps of:
diffusing oxygen in small fine bubbles at the bottom of a water column in an enclosed vessel having headspace;
building headspace pressure above said water column in said enclosed vessel; and
circulating said oxygen from said headspace continuously until a desired oxygen dissolved concentrate of water is obtained.

2. The method of claim 1, wherein said oxygen is pure oxygen.

3. An apparatus for dissolving oxygen into water, comprised of
an enclosed vessel having a bottom, a top and a bottom end,
a plurality of built-in porous metallic diffusers at said bottom of said enclosed vessel,
an agitator at said top of said enclosed vessel, wherein said agitator has a rotary hollow-shaft extending to said bottom end of a water column within said enclosed vessel,
a venturi slot in said rotary hollow-shaft configured to stay above the water level, and
a disc at the bottom end of said rotary hollow-shaft.

4. An apparatus for dissolving oxygen into water according to claim 3, wherein said disc is an impeller.

5. The apparatus for dissolving oxygen into water according to claim 4, wherein there are a plurality of said venturi slot in said rotary hollow-shaft.
